(19) United States
(12) Patent Application Publication
(10) Pub. No.: US 2009/0166189 A1
(43) Pub. Date: Jul. 2, 2009

(54) WASHING APPARATUS FOR FABRICATING PLATING-FILMED WEB

(75) Inventor: Hirokazu Saitou, Kanagawa (JP)

Correspondence Address: YOUNG & THOMPSON, 209 Madison Street, Suite 500, ALEXANDRIA, VA, 22314, US

(73) Assignee: FUJIFILM CORPORATION, TOKYO (JP)

(21) Appl. No.: 11/994,414

(22) PCT Filed: Mar. 20, 2007
(86) PCT No.: PCT/JP2007/056509

§ 371 Date: Jan. 2, 2008

(30) Foreign Application Priority Data
Mar. 31, 2006 (JP) 2006-100695

(51) Int. Cl. C25B 9/00; B08B 3/00

(52) U.S. Cl. 204/242; 134/133

(57) ABSTRACT

A washing apparatus provided with a washing liquid-holding reservoir and the component which supplies washing liquid to the washing liquid-holding reservoir. At an electroplate solution, a conductive surface of a web is caused to touch against a cathode roller, and a plating film is formed at the conductive surface. The washing apparatus is disposed at a downstream side of the electroplate solution. The washing apparatus washes a roller which conveys the web through midair toward a subsequent stage. A lower portion of the roller is dipped in the washing liquid at the washing liquid-holding reservoir.

### TECHNICAL FIELD

The present invention relates to a washing apparatus for washing a roller, which is employed in a plating-filmed web fabrication apparatus which conveys a long, wide, belt-form web with a plurality of rollers while forming a plating film at a conductive surface of the web, and to an apparatus for fabricating a plating-filmed web, which is equipped with this washing apparatus.

### BACKGROUND ART

Heretofore, when plating is to be performed continuously on a long, wide, belt-form web, the web spans between a plurality of rollers and the web is conveyed in a certain direction by rotation of the rollers, and is passed through a plating solution reservoir. When a web is conveyed by a plurality of rollers in this way, there is a problem in that precipitants of plating liquid components, pollutants and the like firmly adhere to the rollers at a downstream side from the plating solution reservoir.

In order to wash the rollers, for example, Japanese Patent Application Laid-Open (JP-A) No. 2005-264193 has disclosed a structure which causes a rotating brush, which is sprayed with washing water, to touch against a roller that is to be washed. Further, JP-A No. 5-279881 has disclosed a process in which a plating liquid in a low-pH state is periodically sprayed to remove soiling that has cumulatively adhered on a surface of a roller.

However, with the structure described in JP-A No. 2005-264193, an apparatus for the rotating brush and an apparatus for spraying the washing water are required, and the equipment thereof is rather large. Consequently, it is extremely difficult to dispose these at arbitrary conveyance rollers, and the interior of an apparatus system will be soiled by occurrences of splashing from the rotating brush(es). Furthermore, the washing water is circulatingly employed, and therefore the washing water becomes soiled over time, and satisfactory washing effects are not obtained.

Furthermore, with the washing process described in JP-A No. 5-279881, because it is not possible to keep the roller in a clean state continuously, damage is caused to the web by soiling which cumulatively adheres to the roller. Moreover, it is not possible to prevent washing water from mixing in with the plating liquid, a change in concentration of the plating liquid occurs, and plating quality becomes unstable.

### DISCLOSURE OF THE INVENTION

The present invention has been devised in consideration of the present circumstances, and an objective of the present invention is to provide a washing apparatus and a plating-filmed web fabrication apparatus which, when plating is being performed while a web is being conveyed by a roller, wash off soiling of plating liquid that has adhered to the roller, efficiently and reliably, with small amounts of washing liquid.

In order to address the problem described above, a first aspect of the present invention is a washing apparatus disposed at a downstream side relative to an electroplate solution, at which a conductive surface of a web is contacted with a cathode roller and a plating film is formed at the conductive surface, the washing apparatus washing a roller which conveys the web through midair toward a subsequent stage, and the washing apparatus including: a washing liquid-holding reservoir in which a lower portion of the roller is dipped; and a supply component which supplies washing liquid to the washing liquid-holding reservoir.

According to the first aspect of the present invention, the lower portion of the roller which conveys the web through midair is dipped in the washing liquid of the washing liquid-holding reservoir. The washing liquid is supplied to the washing liquid-holding reservoir by the supply component. Thus, in accordance with rotation of the roller, the lower portion of the roller is washed by the washing liquid, and a surface of the roller is kept in a clean state. Furthermore, because the washing liquid touches only the lower portion of the roller, small amounts are sufficient. Therefore, it is possible to efficiently and reliably wash off soiling, such as plating liquid and the like that has adhered to the roller, with small amounts of the washing liquid.

In the washing apparatus of the first aspect of the present invention, an overflow weir may be provided at a side portion of the washing liquid-holding reservoir, the overflow weir allowing washing liquid in the washing liquid-holding reservoir to overflow for keeping a quantity of the washing liquid constant.

According to this structure, because the overflow weir is provided at the side portion of the washing liquid-holding reservoir, the washing liquid in the washing liquid-holding reservoir overflows and the amount of washing liquid is kept constant. Therefore, it is possible to regulate the quantity of washing liquid in the washing liquid-holding reservoir at low cost.

In the washing apparatus of the first aspect of the present invention, the supply component may include: a washing liquid stored reservoir at which a water level is held constant; a liquid supply path at which a head difference between the washing liquid stored reservoir and the washing liquid-holding reservoir is constant; and a flow regulating valve provided at the liquid supply path.

According to this structure, the washing liquid stored reservoir in which the water level is held constant is provided, and the washing liquid is supplied to each washing liquid-holding reservoir along the liquid supply path for which the head difference between the washing liquid stored reservoir and the washing liquid-holding reservoir is constant. The flow regulating valve is provided on the liquid supply path, and amounts of the washing liquid supplied to the washing liquid-holding reservoir are kept constant. Consequently, shortages of the washing liquid being supplied to the washing liquid-holding reservoir are suppressed.

In the washing apparatus of the first aspect of the present invention, a flexible blade may be provided in the washing liquid of the washing liquid-holding reservoir, the flexible blade abutting against a peripheral surface of the roller.

According to this structure, the flexible blade is provided, which abuts against the peripheral surface of the roller within the washing liquid of the washing liquid-holding reservoir. The flexible blade removes soiling that has adhered to the roller, and occurrences of precipitants of the plating liquid at the roller surface are suppressed.

An apparatus for fabricating a plating-filmed web of a second apparatus of the present invention includes: an electroplate solution, at which a conductive surface of a web is contacted with a cathode roller and a plating film is formed at the conductive surface; a roller disposed at a downstream side relative to the electroplate solution, which conveys the web through midair toward a subsequent stage; and the washing apparatus of the first aspect, which washes the roller.

According to the second aspect of the present invention, the roller for conveying the web through the midair to the subsequent stage is provided at the downstream side of the electroplate solution, and this roller is washed by the washing apparatus of the first aspect of the present invention. Thus, soiling, such as plating liquid and the like, that has adhered to the roller can be washed off efficiently and reliably with small amounts of the washing liquid.

The present invention, being structured as described above, can, while a long, wide, belt-form web is being conveyed by a roller and plating is being performed continuously, wash off plating liquid, pollutants and the like that adhere to the roller efficiently and reliably with small quantities of washing liquid.

### BRIEF DESCRIPTION OF THE DRAWINGS

FIG. 1 is a schematic vertical sectional view showing a plating-filmed web fabrication apparatus of an embodiment of the present invention.

FIG. 2 is a schematic sectional view showing a washing apparatus of a roller, which is disposed at an electroplate apparatus employed in the fabrication apparatus shown in FIG. 1.

FIG. 3 is an enlarged partial view showing a vicinity of a washing liquid-holding reservoir of the roller washing apparatus shown in FIG. 2.

### BEST MODE FOR CARRYING OUT THE INVENTION

An embodiment of the present invention will be described on the basis of the drawings. Herein, members having substantially the same functions are assigned the same reference numerals throughout the drawings, and duplicative descriptions may be omitted.

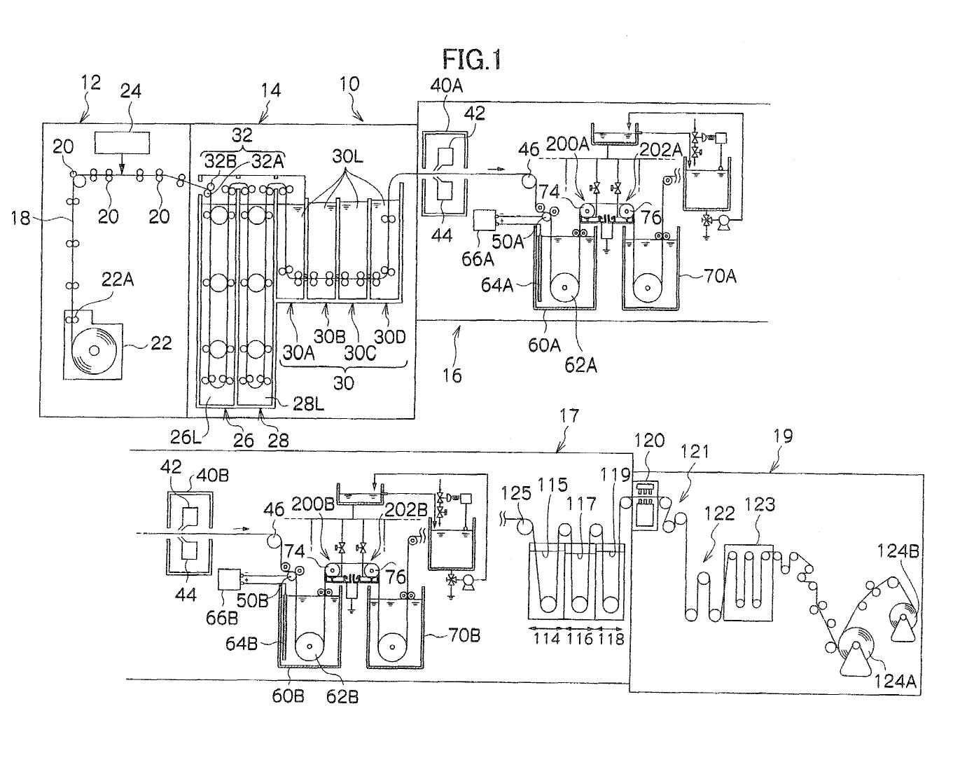

FIG. 1 is a schematic structural diagram showing a plating-filmed web (for example, a plating-coated film and the like) fabrication apparatus 10 at which a washing apparatus 200A relating to the embodiment of the present invention is installed.

As shown in FIG. 1, this plating-filmed web fabrication apparatus 10 is structured with an exposure apparatus 12, a developing apparatus 14, an electroplate apparatus 16 provided with a washing apparatus 70A, a post-processing apparatus 17, and a winding apparatus 19.

First, the exposure apparatus 12 will be described. The exposure apparatus 12 is an apparatus for performing exposure of a required microline pattern (for example, a lattice pattern, a honeycomb pattern or the like) while conveying a light-transmissive photosensitive web 18. The photosensitive web 18 is formed of a long, wide belt-form web (for example, a long, wide belt-form film) at which a layer containing silver salt is provided and which serves as a material to be plated. By this pattern exposure, a patterned microline-form metallic silver portion is formed at exposed portions of the silver salt-containing layer of the photosensitive web 18.

A plurality of conveyance roller pairs 20 are provided in the exposure apparatus 12, along a conveyance path of the light-transmissive photosensitive web 18. The conveyance roller pairs 20 are structured with driving rollers and nipping rollers.

A supply section is provided in the exposure apparatus 12, at a portion that is furthest upstream in the conveyance direction. A magazine 22 is installed at the supply section. The magazine 22 accommodates the long, wide, belt-form light-transmissive photosensitive web 18, which has been wound up into a roll. Drawing out rollers 22A are provided at the light-transmissive photosensitive web 18, which draw out the light-transmissive photosensitive web 18 and convey the light-transmissive photosensitive web 18 to the downstream side.

An exposure unit 24 is provided at the conveyance direction downstream side from the supply section. The exposure unit 24 implements exposure onto the light-transmissive photosensitive web 18. The exposure unit 24 may be a continuous surface exposure unit which employs a photomask, and may be a scanning exposure unit with a laser beam. Such a scanning exposure unit can preferably employ a scanning exposure system which utilizes a gas laser, light-emitting diodes, a semiconductor laser or a monochromatic high-density light, such as a second harmonic generation light source (SHG) in which a semiconductor laser or a solid state laser employing a semiconductor laser for an excitation light source is combined with a nonlinear optical crystal, or the like. Further, the scanning exposure unit can also employ a scanning exposure system which utilizes a KrF excimer laser, an ArF excimer laser, an F2S laser or the like.

Further, in order to make the scanning exposure unit more compact and inexpensive, the light source thereof may employ a semiconductor laser or a second harmonic generation light source (SHG) in which a semiconductor laser or a solid state laser is combined with a nonlinear optical crystal. In particular, a semiconductor laser may be employed in order to design a device which is compact, inexpensive, long-lasting and highly stable.

As a laser light source of the scanning exposure unit, specifically, it is possible to preferably employ a blue semiconductor laser with wavelength 430 to 460 nm (presented by Nichia Corporation at the 48th meeting of the Japan Society of Applied Physics and Related Societies, March, 2001), a green laser of around 530 nM in which a semiconductor laser (emission wavelength around 1060 nm) is wavelength-converted by an SHG crystal of LiNbO₃ with a waveguide-form inversion domain structure and emitted, a red semiconductor laser with wavelength around 685 nm (HITACHI Type No. HL6738MG), a red semiconductor laser with wavelength around 650 nm (HITACHI Type No. HL6501MG) or the like.

The exposure apparatus 12 is not limited to the structures described above. It is also possible to employ usual exposure devices which are used for silver salt photographic films, printing papers, platemaking films, photomask emulsion masks, and the like.

Next, the developing apparatus 14 will be described. The developing apparatus 14 is disposed at the conveyance direction downstream side of the exposure apparatus 12, and is an apparatus which performs development, fixing and washing of the light-transmissive photosensitive web 18 which has been subjected to the exposure of the required microline pattern.

The developing apparatus 14 is provided with a developing tank 26, a bleaching and fixing tank 28 and a rinsing tank 30, in that order from the conveyance direction upstream side. The rinsing tank 30 is formed with a first rinsing tank 30A, a second rinsing tank 30B, a third rinsing tank 30C and a fourth rinsing tank 30D. In the developing tank 26, for example, a developing liquid 26L is stored in a predetermined amount, in the bleaching and fixing tank 28, a bleaching and fixing liquid 28L is stored in a predetermined amount, and in the rinsing tank 30A to 30D, a washing liquid 30L is stored in predetermined amounts. The photosensitive web 18 is conveyed in the liquids of the respective processing tanks 26 to 30 by rollers and guides in the processing tanks 26 to 30. Thus, the photosensitive web 18 is subjected to the respective processes of developing, fixing and washing. At a furthest upstream side of the developing tank 26, a feed-in roller pair 32 is provided, which is equipped with a driving roller 32A and a roller 32B which rotates in accordance with rotation of the driving roller 32A. This feed-in roller pair 32 guides the photosensitive web 18 which is fed out from the exposure apparatus 12 into the developing liquid 26L.

Here, usual development and processing techniques which are used for silver salt photographic films, platemaking films, photomask emulsion masks and the like can be employed for the respective processes of development, fixing and washing. The developing liquid 26L, the bleaching and fixing liquid 28L and the washing liquid 30L can also be suitably employed on that basis. For example, the developing liquid 26L is not particularly limited, but a PQ developer, an MQ developer, an MAA developer or the like can be employed. For example, a developer such as CN-16, CR-56, CP45X, FD-3 or PAPITOL manufactured by FUJIFILM, C-41, E-6, RA-4, D-19 or D-72 manufactured by KODAK or the like, such developers contained in kits, or a lith developer such as D-85 or the like can be used. Here, the fixing processing is carried out with the objective of removing and stabilizing an unexposed portion of the silver salts.

It is also possible to include an image quality-improving agent in the developing liquid 26L, with a view to improving image quality. An image quality-improving agent can be, for example, a nitrogen-containing heterocyclic compound such as benzotriazol or the like. Further, in a case of employing a lith developer, it is particularly preferable to use polyethylene glycol.

The photosensitive web 18 that has passed through the respective processing tanks 26 to 30 of the developing apparatus 14 is ejected from the developing apparatus 14 without being dried.

Next, the electroplate apparatus 16 will be described. The electroplate apparatus 16 is an apparatus which applies electroplate processing to the photosensitive web 18, which has been subjected to exposure and development to form the microline-form metallic silver portion, and forms a plating (a conductive metallic portion) at which conductive particles are carried at the metallic silver portion.

In the electroplate apparatus 16, a moisture removal device 40A, which removes moisture from the photosensitive web 18 that has passed through the rinsing tank 30, is disposed at the photosensitive web 18 conveyance direction upstream side. In the moisture removal device 40A, air knife devices 42 and 44 are disposed at each of two sides of the photosensitive web 18. The air knife devices 42 and 44 blow air knives from the two sides of the photosensitive web 18, and thus remove moisture that has adhered to the photosensitive web 18.

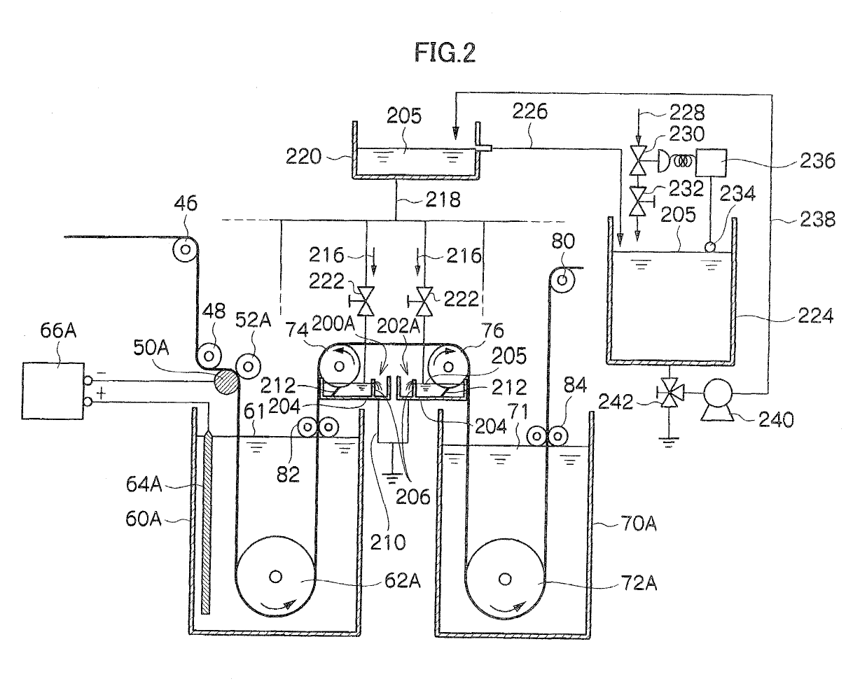

As shown in FIG. 2, the photosensitive web 18 which has passed through the moisture removal device 40A is guided by a support roller 46 and a support roller 48 and conveyed to a cathode roller 50A, which implements electricity supply while touching against the metallic silver portion of the photosensitive web 18. A resilient roller 52A is disposed at a position opposing the cathode roller 50A with the photosensitive web 18 sandwiched therebetween, and causes the metallic silver portion of the photosensitive web 18 to contact the cathode roller 50A. At the resilient roller 52A, a resilient layer formed of rubber or the like is provided at an outer peripheral face of a rotatably supported core piece. Urethane rubber or the like is used for the resilient layer. The photosensitive web 18 can be caused to closely contact the cathode roller 50A by the resilient roller 52A being pressed thereagainst.

At the photosensitive web 18 conveyance direction downstream side relative to the cathode roller 50A, a plating reservoir 60A is disposed, which is filled with a plating liquid 61. At this stage, the metallic silver portion of the photosensitive web 18 which has been touched against the cathode roller 50A is conveyed by a submerged roller 62A in the plating solution of the plating reservoir 60A. A case 64A, which is laminarly filled with copper balls, serves as an anode electrode and the cathode roller 50A serves as a cathode electrode, electricity is supplied by a DC power supply (rectifier) 66A, and thus a layer-form plating coat is formed on the photosensitive web 18. In the present embodiment, electricity is supplied from the cathode roller 50A to the case 64A which is the anode electrode by the DC power supply 66A, and a current density at the photosensitive web 18 is set to 0.2 to 10 A/dm² to form the plating coat.

For this electroplate processing, an electroplate technique which is used for, for example, printed circuit boards or the like can be employed. Electrolytic copper-plating is preferable as the electroplate. In the present embodiment, an electrolytic copper-plating solution is employed as the plating liquid 61. The electrolytic copper-plating solution may be a copper sulfate solution, a copper pyrophosphate solution, a copper fluoroborate solution or the like. Chemical species which can be included in the electrolytic copper-plating solution include: copper sulfate, copper chloride or the like; a sulfate which enables increases in stability and conductivity of the plating solution and more uniform electrodeposition; chlorine, for effects of promoting dissolution of the anode and assisting additives; polyethylene oxide as an additive for improving stability of the solution and plating fineness; bipyridine; and so forth.

Anyway, in this structure, a circulation pipe communicates with a lower portion of the plating reservoir 60A. The plating liquid 61 in the plating reservoir 60A is supplied to the circulation pipe, is passed through a filter to remove foreign bodies in the plating liquid 61, and is returned into the plating reservoir 60A.

As shown in FIG. 2, a washing apparatus 70A is disposed at the photosensitive web 18 conveyance direction downstream side relative to the plating reservoir 60A. The washing apparatus 70A is filled with washing water 71 for washing the photosensitive web 18. Two rollers 74 and 76 for conveying the photosensitive web 18 through the midair are disposed substantially horizontally, above an upper portion of the plating reservoir 60A and the washing apparatus 70A. The rollers 74 and 76 rotate in accordance with movement of the photosensitive web 18. Further, a submerged roller 72A is provided in the washing apparatus 70A. Accordingly, the photosensitive web 18 passes through in the plating liquid 61 in the plating reservoir 60A, is guided by the two rollers 74 and 76, and is conveyed into the washing water 71 of the washing apparatus 70A. The photosensitive web 18 that has passed through the washing apparatus 70A is guided and conveyed by the submerged roller 72A and a support roller 80 which is disposed thereabove.

A pair of liquid-extracting rollers 82, which press against front and rear of the photosensitive web 18, are disposed at an upper portion of the plating reservoir 60A, at the conveyance direction upstream side relative to the roller 74. Further, a pair of liquid-extracting rollers 84, which press against the front and rear of the photosensitive web 18, are disposed at an upper portion of the washing apparatus 70A, at the conveyance direction upstream side relative to the support roller 80. The liquid-extracting rollers 82 and 84 rotate in accordance with movement of the photosensitive web 18. Peripheral surfaces of the liquid-extracting rollers 82 touch the plating liquid 61 and peripheral surfaces of the liquid-extracting rollers 84 touch the washing water 71. Thus, the liquid-extracting rollers 82 and 84 are continuously employed in wet states. The liquid-extracting rollers 82 and 84 are formed of, for example, PVA (polyvinyl alcohol). With this structure, the plating liquid 61 that has adhered to the photosensitive web 18 is squeezed off by the liquid-extracting rollers 82, and the washing water 71 that has adhered to the photosensitive web 18 is squeezed off by the liquid-extracting rollers 84.

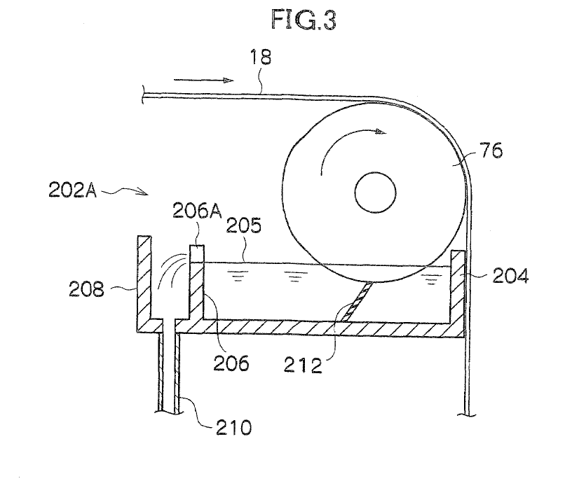

The washing apparatus 200A and a washing apparatus 202A, which wash the rollers 74 and 76, respectively, are provided below the roller 74 and the roller 76. The washing apparatuses 200A and 202A are disposed with left-right symmetry, and are structured by respectively matching members. Here, an example of the washing apparatus 202A will be described on the basis of FIG. 3.

As shown in FIG. 3, the washing apparatus 202A is provided with a gutter-like washing liquid-holding reservoir 204, which is filled with washing water 205, at a portion at a lower side of the roller 76, and a lower portion of the roller 76 is dipped in the washing water 205. The washing liquid-holding reservoir 204 is arranged along the length direction of the roller 76, and is formed with a length which accommodates the whole length of the roller 76. At a side portion of the washing liquid-holding reservoir 204, an overflow weir 206 is provided. A cutaway aperture 206A is formed in an upper portion of the overflow weir 206. With this structure, the washing water 205 in the washing liquid-holding reservoir 204 is allowed to overflow at this cutaway aperture 206A, and a quantity of the washing water 205 is kept constant. The roller 76 is set such that a third to a tenth of the diameter thereof is dipped in the washing water 205.

At a sideward portion adjacent to the overflow weir 206 of the washing liquid-holding reservoir 204, a drainage channel 208 is provided. The washing water 205 that has overflowed flows in the drainage channel 208. A drainage pipe 210 is connected to a floor portion of the drainage channel 208, and the washing water 205 passes along the drainage pipe 210 and is drained.

At a lower side portion within the washing liquid-holding reservoir 204, a flexible blade 212 is provided which abuts against the peripheral surface (the length direction surface) of the roller 76. The flexible blade 212 is disposed to be angled toward an upstream side with respect to a direction of rotation of the roller 76, and presses against the roller 76 with a constant pressure. The flexible blade 212 abuts against the peripheral surface of the roller 76 within the washing water 205, and is structured so as to scrape off soiling, adherents and the like that have adhered to the peripheral surface of the roller 76. The flexible blade 212 is formed of, for example, resin, rubber or the like.

As shown in FIG. 2, a supply pipe 216, which supplies the washing water 205, is connected to the washing liquid-holding reservoir 204. A washing liquid stored reservoir 220 is disposed at a portion upward of the washing liquid-holding reservoir 204. The washing water 205 is stocked in the washing liquid stored reservoir 220, with a predetermined water level due to an overflow pipe 226, which will be described later. A single inflow pipe 218 is connected to a floor portion of the washing liquid stored reservoir 220. A plurality of the supply pipe 216 branch off from the inflow pipe 218 and are connected to the respective washing liquid-holding reservoirs 204. The inflow pipe 218 and the supply pipes 216 are structured such that a head difference between the washing liquid stored reservoir 220 and the respective washing liquid-holding reservoirs 204 is constant. Hence, utilizing the head between the washing liquid stored reservoir 220 and each washing liquid-holding reservoir 204, the washing water 205 in the washing liquid stored reservoir 220 passes along the inflow pipe 218 and the supply pipes 216 and is supplied to each washing liquid-holding reservoir 204. A flow regulating valve 222 is provided on the supply pipe 216, and regulates to keep flow amounts of the washing water 205 being supplied to the washing liquid-holding reservoir 204 substantially constant. Thus, shortages of the washing water 205 being supplied to the washing liquid-holding reservoir 204 can be avoided. Moreover, because a flowmeter is not required, costs can be reduced.

A washing liquid storage reservoir 224, in which the washing water 205 is stored, is disposed diagonally to the lower side of the washing liquid stored reservoir 220. The overflow pipe 226 is connected to a side wall of the washing liquid stored reservoir 220, and another end of the overflow pipe 226 is connected to the washing liquid storage reservoir 224. Therefore, the washing water 205 passes through the overflow pipe 226 from the washing liquid stored reservoir 220 and drains into the washing liquid storage reservoir 224, and the water level of the washing water 205 in the washing liquid stored reservoir 220 is kept constant.

A supply pipe 228, which supplies fresh washing water 205, is connected to the washing liquid storage reservoir 224. Flow regulating valves 230 and 232 are provided on the supply pipe 228. A sensor 234, which senses the surface of the washing water 205, is provided in the washing liquid storage reservoir 224. The water surface is sensed by the sensor 234, and the flow regulating valve 230 is controlled by a control section 236. Thus, the liquid surface level of the washing water 205 is regulated.

A supply pipe 238, which supplies the washing water 205 to the washing liquid stored reservoir 220, is connected to a floor portion of the washing liquid storage reservoir 224. A pump 240 and a flow regulating valve 242 are provided on the supply pipe 238. Accordingly, the washing water 205 which has been stored in the washing liquid storage reservoir 224 passes along the supply pipe 238 and is delivered to the washing liquid stored reservoir 220.

In the electroplate apparatus 16 with the structure described above, first, the long, broad photosensitive web 18 is conveyed in the direction of the arrows, and moisture that has adhered to the photosensitive web 18 is removed by the air knife devices 42 and 44. Then, at the nipping portion between the cathode roller 50A and the resilient roller 52A, the metallic silver portion of the photosensitive web 18 is made to contact the cathode roller 50A, and is thereafter conveyed to the plating reservoir 60A. Here, with the case 64A in which copper balls are layered and loaded serving as the anode electrode and the cathode roller 50A serving as the cathode electrode, electricity is supplied by the DC power supply 66A. Thus, a copper-plating film is formed by electroplating of the metallic silver portion of the photosensitive web 18. Then, after the photosensitive web 18 has passed through the plating reservoir 60A, the photosensitive web 18 is guided by the rollers 74 and 76 and conveyed to the washing apparatus 70A, and plating liquid that has adhered to the photosensitive web 18 is washed off by the washing water 71.

In addition, the electroplate apparatus 16 is provided with the washing apparatuses 200A and 202A for washing the rollers 74 and 76. For the washing apparatuses 200A and 202A, the fresh washing water 205 is supplied through the supply pipe 228 to the washing liquid storage reservoir 224, and the washing water 205 stored in the washing liquid storage reservoir 224 passes through the supply pipe 238 and is temporarily stocked in the washing liquid stored reservoir 220. At the washing liquid stored reservoir 220, the washing water 205 is maintained at a predetermined water level because of the overflow pipe 226. Then, utilizing the head between the washing liquid stored reservoir 220 and the washing liquid-holding reservoir 204, the washing water 205 in the washing liquid stored reservoir 220 passes through the inflow pipe 218 and the supply pipes 216 and is supplied to each washing liquid-holding reservoir 204. At this time, flow amounts of the washing water 205 that is supplied to each washing liquid-holding reservoir 204 are regulated to be substantially constant by the flow regulating valve 222.

In the washing liquid-holding reservoir 204, the amount of the washing water 205 is kept constant because of the overflow weir 206, and the lower portion of the rotating roller 74 or 76 is respectively dipped. Accordingly, the peripheral surface of the roller 74 or 76 is washed by the washing water 205, and plating liquid, pollutants and the like that have adhered to the peripheral surface of the roller 74 or 76 are removed. Furthermore, the flexible blade 212 abuts against the peripheral surface of the roller 74 or 76 and pollutants that have adhered to the peripheral surface of the roller 74 or 76 are scraped off. Consequently, the peripheral surfaces of the rollers 74 and 76 are kept in clean states.

The washing water 205 that overflows from the washing liquid-holding reservoir 204 through the overflow weir 206 flows through the drainage channel 208 and is drained through the drainage pipe 210.

With these washing apparatuses 200A and 202A, plating liquid, pollutants and the like that have adhered to the rollers 74 and 76 can be washed off efficiently and reliably with small amounts of the washing water 205. Consequently, occurrences of scratching and the like at the photosensitive web 18 due to pollutants and precipitants of plating liquid components at the rollers 74 and 76 can be suppressed.

In the electroplate apparatus 16, a unit equipped with the moisture removal device 40A, the cathode roller 50A, the plating reservoir 60A and the washing apparatus 70A is plurally provided (eight units in the present embodiment), and the steps described above are repeated a number of times. Thus, copper plating with a predetermined thickness is formed at the photosensitive web 18.

Further, at the photosensitive web 18 conveyance direction downstream side therefrom, a unit for implementing nickel plating is plurally provided (eight units in the present embodiment), which is equipped with a moisture removal device 40B, a cathode roller 50B, a plating reservoir 60B and a washing apparatus 70B. This unit repeatedly performs steps the same as those described above a number of times. Thus, a nickel-plating coat with a predetermined thickness is formed at the photosensitive web 18.

Thereafter, as shown in FIG. 1, the photosensitive web 18 passes a roller 125 which can sense tension of the web, through a washing section 114 containing washing water 115 for removing plating liquid, an antirust treatment section 116 containing an antirust treatment liquid 117 for protecting the plating film, and a washing section 118 containing washing water 119 for removing excess antirust processing liquid, through a drying stage section 120 with a drying fan for removing moisture, through a speed regulation section 121 and through a balance roller section 122, and tension is adjusted. Then, the photosensitive web 18 passes through an accumulator 123 and is formed into web rolls 124. In this way, a coating-filmed web is provided.

A practical web conveyance tension is preferably at least 5 N/m and at most 200 N/m. In practice, if the tension were less than 5 N/m, the web would start to meander, and control of the conveyance path would be difficult. If the tension exceeded 200 N/m, the plating filmed metals formed at the web would have internal strains, and consequently there would be problems such as curl occurring in the finished product and suchlike.

For conveyance tension control, the conveyance tension may be detected using the tension-sensing roller 125, and feedback control may be performed to increase/reduce speed with the speed regulation section 121 so as to keep the tension value constant.

In this way, a plating (a conductive metallic portion) is formed at the microline metallic silver portion of the photosensitive web 18. By such steps, a plating-filmed web can be obtained.

Herein, the number of plating reservoirs of the electroplate apparatus 16 may be increased beyond eight sets in accordance with a required plating thickness (thickness of the conductive metallic portion). In accordance with the number of reservoirs, the required plating thickness (conductive metallic portion thickness) can be obtained with ease.

Next, the photosensitive web 18 will be described. The photosensitive web 18 which serves as a material to be plated is, for example, a long, broad, flexible base material formed of a photosensitive material, which is provided with, on a light-transmissive support, a silver salt-containing layer which includes silver salt (for example, silver halide). A protective layer may be further provided on the silver salt-containing layer. This protective layer means, for example, a layer formed of a binder which is gelatin, a high molecular weight polymer or the like. The protective layer is formed on the silver salt-containing layer in order to realize effects of excellent scratch prevention, mechanical characteristics and the like. A thickness of the protective layer is preferably 0.02 to 20 μm, more preferably 0.1 to 10 μm, and even more preferably 0.3 to 3 μm.

In regard to compositions and the like of the silver salt-containing layer, protective layer and the like, silver halide emulsion layers (silver salt-containing layers), protective layers and the like which are used for silver salt photographic films, printing papers, platemaking films, photomask emulsion masks and the like can be suitably employed.

In particular, a silver salt photographic film (i.e., a silver salt photosensitive material) is preferable as the photosensitive web 18 (i.e., the photosensitive material), and a monochrome silver salt photographic film (a monochrome silver salt photosensitive material) is optimal. Furthermore, as the silver salt(s) employed in the silver salt-containing layer, silver halides in particular are most excellent.

Meanwhile, as the light-transmissive support, a single-layer plastic film, or a multi-layer film in which two or more thereof are combined, may be employed. As a raw material of a plastic film, for example, the following can be employed: polyesters such as polyethylene tereplithalate (PET), polyethylene naplithalate and the like; polyolefins such as polyethylene (PE), polypropylene (PP), polystyrene, EVA and the like; vinyl-based resins such as polyvinyl chloride, polyvinylidene chloride and the like; and alternatively, polyether ether ketones (PEEK), polysulfones (PSF), polyether sulfones (PES), polycarbonates (PC), polyamides, polyimides, acrylic resins, triacetyl cellulose (TAC) and so forth.

Among these, in regard to transparency, heat resistance, ease of handling and cost, a plastic film to serve as the support is preferably a polyethylene terephthalate film, cellulose triacetate film or the like which is ordinarily employed for a silver salt photographic film (a silver salt photosensitive material), or alternatively a polyimide film. In particular, a polyethylene terephthalate film is most preferable.

Further, in a case of an electromagnetic wave-shielding member for a display, because transparency is required, it is desirable that transparency of the support be high. In such a case, light transmittance of the light-transmissive support over all visible wavelengths is preferably 70 to 100%, more preferably 85 to 100%, and particularly preferably 90 to 100%.

A width of the photosensitive web 18 may be, for example, 50 cm or more, and a thickness may be 50 to 200 μm.

After exposure and development of the photosensitive web 18, the metallic silver portion is formed at the exposed portion. A mass of metallic silver that is included in this metallic silver portion is preferably a content ratio of at least 50% by mass relative to a mass of silver that was included at the exposed portion before exposure, and is more preferably at least 80% by mass. If the mass of silver included at the exposed portion is 50% by mass or more relative to the mass of silver that was included at the exposed portion before exposure, then it will be possible to provide high conductivity with the subsequent electroplate processing, and therefore this is preferable.

In order to provide conductivity to the metallic silver portion that is formed by the exposure and development processing, the electroplate processing is performed by the above-described electroplate apparatus 16 to cause conductive metallic particles to be carried at the metallic silver portion. That is, in the plating-filmed web fabrication apparatus 10, the light-transmissive photosensitive web 18 provided with the silver salt-containing layer is utilized as a material to be plated, exposure and development are applied to the silver salt-containing layer thereof, and a required microline-form metallic silver portion is formed as a portion to be plated. Because this microline-form metallic silver portion is formed by exposing and developing the silver salt-containing layer, the microline-form metallic silver portion is patterned with extremely fine microlines. When the electroplate processing is applied to this light-transmissive photosensitive web 18, conductive particles are supported on the microline-form metallic silver portion, and thus the conductive metallic portion is formed. Consequently, an electromagnetic wave-shielding member that is provided features a microline-form metallic portion which is patterned by extremely fine microlines and a light-transmissive portion with a large surface area.

In the plating-filmed web fabrication apparatus 10 which is formed thus, because the washing apparatuses 200A and 202A are provided for washing the rollers 74 and 76 which convey the photosensitive web 18, cases of plating liquid adhering to the rollers 74 and 76, when the photosensitive web 18 is conveyed from the plating reservoir 60A, and plating liquid components precipitating and solidifying are suppressed. Therefore, there will be no scratching of the photosensitive web 18 or adherence of dust-like solids or the like due to precipitants at the surfaces of the rollers 74 and 76, and high-quality plating will be obtained.

Further, the rollers 74 and 76 and the photosensitive web 18 can be efficiently and reliably washed continuously by the washing apparatuses 200A and 202A with small amounts of the washing water 205. Consequently, a burden of washing processing and the like at the time of plating is greatly reduced, an improvement in production efficiency can be achieved, and a finished product can be provided at lower cost.

Anyway, in the present embodiment, the washing water 205 of the washing liquid-holding reservoir 204 in which the roller 74 or 76 is dipped is overflowed for draining. However, a structure is also possible in which the downstream side washing liquid-holding reservoir 204, in which the roller 76 is dipped, circulatingly employs the washing water 205.

Further, in the present embodiment, the washing water 205 is employed as a washing liquid, but this is not limited to water. Another washing liquid could be employed, such as an alkaline washing liquid, an acidic washing liquid or the like.

1. A washing apparatus comprising:
a washing liquid-holding reservoir; and
a supply component which supplies washing liquid to the washing liquid-holding reservoir,
wherein the washing apparatus is disposed at a downstream side relative to an electroplate solution, at which a conductive surface of a web is contacted with a cathode roller and a plating film is formed at the conductive surface, and the washing apparatus washes a roller which conveys the web through midair toward a subsequent stage, and
a lower portion of the roller is dipped in the washing liquid at the washing liquid-holding reservoir.

2. The washing apparatus of claim 1, wherein an overflow weir is provided at a side portion of the washing liquid-holding reservoir, the overflow weir allowing washing liquid in the washing liquid-holding reservoir to overflow for keeping a quantity of the washing liquid constant.

3. The washing apparatus of claim 1, wherein the supply component comprises:
a washing liquid stored reservoir at which a water level is held constant;
a liquid supply path at which a head difference between the washing liquid stored reservoir and the washing liquid-holding reservoir is constant; and
a flow regulating valve provided at the liquid supply path.

4. The washing apparatus of claim 1, wherein a flexible blade is provided at a lower portion in the washing liquid-holding reservoir, the flexible blade abutting against a peripheral surface of the roller within the washing liquid.

5. An apparatus for fabricating a plating-filmed web, comprising:
an electroplate solution, at which a conductive surface of a web is contacted with a cathode roller and a plating film is formed at the conductive surface;
a roller disposed at a downstream side relative to the electroplate solution, which conveys the web through midair toward a subsequent stage; and
a washing apparatus which washes the roller, the washing apparatus including
a washing liquid-holding reservoir and
a supply component which supplies washing liquid to the washing liquid-holding reservoir,
wherein the washing apparatus is disposed at the downstream side relative to the electroplate solution, and
a lower portion of the roller is dipped in the washing liquid at the washing liquid-holding reservoir.

6. The apparatus for fabricating a plating-filmed web of claim 5, wherein an overflow weir is provided at a side portion of the washing liquid-holding reservoir, the overflow weir allowing washing liquid in the washing liquid-holding reservoir to overflow for keeping a quantity of the washing liquid constant.

7. The apparatus for fabricating a plating-filmed web of claim 5, wherein the supply component comprises:
a washing liquid stored reservoir at which a water level is held constant;
a liquid supply path at which a head difference between the washing liquid stored reservoir and the washing liquid-holding reservoir is constant; and
a flow regulating valve provided at the liquid supply path.

8. The apparatus for fabricating a plating-filmed web of claim 5, wherein a flexible blade is provided at a lower portion in the washing liquid-holding reservoir, the flexible blade abutting against a peripheral surface of the roller within the washing liquid.
